(19) United States
(12) Patent Application Publication
(10) Pub. No.: US 2015/0318967 A1
(43) Pub. Date: Nov. 5, 2015

(54) METHOD AND DEVICE FOR TRANSMITTING INFORMATION

(71) Applicant: Huawei Technologies Co., Ltd., Shenzhen (CN)

(72) Inventors: Yongxia Lyu, Beijing (CN); Wen Zhang, Shenzhen (CN); Tong Ji, Beijing (CN)

(21) Appl. No.: 14/800,373

(22) Filed: Jul. 15, 2015

Related U.S. Application Data
(63) Continuation of application No. PCT/CN2013/070721, filed on Jan. 18, 2013.

(51) Int. Cl. H04L 5/00; H04W 72/04

(52) U.S. Cl. CPC H04L 5/0044; H04L 5/0007; H04L 5/0064; H04W 72/0406

(57) ABSTRACT

A method and device for transmitting information are provided, and transmission efficiency in a case of a low code rate is ensured. The method includes: determining the number of groups M and/or a group size N, where M is an integer greater than 1, and N is an integer greater than 1 or equal to 1; processing, according to M and/or N, an information stream to be grouped to obtain M groups of information streams to be sent; and sending, separately over M different time-frequency resources, the M groups of information streams to be sent, where the number of symbols in each time-frequency resource of the M different time-frequency resources is greater than 4.

### CROSS-REFERENCE TO RELATED APPLICATIONS

This application is a continuation of International Application No. PCT/CN2013/070721, filed on Jan. 18, 2013, which is hereby incorporated by reference in its entirety.

### TECHNICAL FIELD

Embodiments of the present invention relate to the field of communications technologies, and in particular, to a method and device for transmitting information.

### BACKGROUND

As an important part of a new-generation information technology, Internet of Things (IOT) refers to a network that acquires information about the physical world by deploying various devices having certain capabilities of perception, calculation, execution, and communication, and implements information transmission, coordination, and processing by using the Internet, so as to implement interconnections between a human and a thing, and between things. It is generally believed that a first stage of the Internet of Things is called machine to machine (M2M), that is, implementing free communication between machines. For a communications network (such as a mobile cellular network), a communications service that it bears is called a machine type communication (MTC) service.

A Long Term Evolution (LTE) project is a biggest new technical research and development project initiated in recent years by the 3rd Generation Partnership Project (3GPP). The technology that uses fundamental technologies of orthogonal frequency division multiplexing (OFDM)/multiple-input multiple-output (MIMO) can provide downlink 100 Mbps and uplink 50 Mbps peak rates over a spectral bandwidth of 20 MHz, and can improve performance of a cell edge user, enhance cell capacity, and lower a system delay. A performance advantage of the LTE system brings many benefits. With development, an M2M device may combine closely with LTE, and the number of M2M devices may become very huge. By that time, a large amount of random or periodical reported data may be generated probably from various specific applications of an MTC, such as a wireless water meter or electricity meter, a vending machine, or a pos machine.

The 3GPP specifically establishes a project group to research enhancement or optimization of a mobile communications network required by introduction of an MTC device, where a coverage issue is one of key issues concerned by an operator. For example, an important application of an MTC user equipment is a smart meter. Generally speaking, a smart meter is generally installed in a basement of a house, or isolated by using a metal shell. In this case, the MTC device may experience a more severe path loss than a common user equipment, for example, path loss increased by extra 20 dB, that is, coverage is required to increase by at least 20 dB to meet a requirement. According to a table of minimum coupling loss (MCL) in the 3GPP, it can known that a rate of a physical uplink shared channel (PUSCH) and that of a physical downlink shared channel (PDSCH) are both 20 kbps, that is, each 1 ms subframe transmits only 20 bits. However, from a table of modulation and coding scheme (MCS) and a table of transport block size (TBS) in the 3GPP, it can known that a minimum TBS size is 16 bits, that is, for a device that requires coverage compensation, the number of bits transmitted in each TTI may be very likely less than 16 bits; a code rate is further increased if a check code is added, thereby causing deteriorated transmission efficiency.

### SUMMARY

Embodiments of the present invention provide a method and device for transmitting information, which can ensure transmission efficiency in a case of a low code rate.

In a first aspect, a method for transmitting information is provided and includes: determining the number of groups M and/or a group size N, where the M is an integer greater than 1, and the N is an integer greater than 1 or equal to 1; processing, according to the M and/or the N, an information stream to be grouped to obtain M groups of information streams to be sent; and sending, separately over M different time-frequency resources, the M groups of information streams to be sent, where the number of symbols in each time-frequency resource of the M different time-frequency resources is greater than 4.

With reference to the first aspect, in a first possible implementation manner, the processing, according to the M and/or the N, an information stream to be grouped to obtain M groups of information streams to be sent includes: adding a cyclic redundancy check code behind the information stream to be grouped; encoding the information stream to be grouped to obtain a bit stream, where the information stream to be grouped is added with the cyclic redundancy check code, and the encoding includes Turbo code encoding or convolutional code encoding; dividing the bit stream into M groups of bit streams to be modulated, where a length of the bit stream is C, and a length of each group of bit streams to be modulated is N; and separately modulating the M groups of bit streams to be modulated to obtain M groups of information streams to be sent.

With reference to the first aspect, in a second possible implementation manner, the processing, according to the M and/or the N, an information stream to be grouped to obtain M groups of information streams to be sent includes: adding a cyclic redundancy check code behind the information stream to be grouped; encoding the information stream to be grouped to obtain a bit stream, where the information stream to be grouped is added with the cyclic redundancy check code, and the encoding includes Turbo code encoding or convolutional code encoding; modulating the bit stream to obtain a symbol stream; and dividing the bit stream into M groups of information streams to be sent, where a length of the symbol stream is C, and a length of each group of information streams to be sent is N.

With reference to the first aspect, in a third possible implementation manner, the processing, according to the M and/or the N, an information stream to be grouped to obtain M groups of information streams to be sent includes: dividing the information stream to be grouped into M groups of information streams to be encoded, where a length of the information stream to be grouped is C, and a length of each group of information streams to be encoded is N; separately performing linear block code encoding on the M groups of information streams to be encoded to obtain M groups of bit streams; and separately modulating the M groups of bit streams to obtain M groups of information streams to be sent.

With reference to the first aspect, in a fourth possible implementation manner, the processing, according to the M and/or the N, an information stream to be grouped to obtain M groups of information streams to be sent includes: dividing the information stream to be grouped into M groups of information streams to be encoded, where a length of the information stream to be grouped is C, a length of each group of information streams to be encoded is N, and the information stream to be grouped includes high-level check information; encoding the M groups of information streams to be encoded to obtain M groups of bit streams, where the encoding includes Turbo code encoding, convolutional code encoding, or linear block code encoding; and modulating the M groups of bit streams to obtain M groups of information streams to be sent.

With reference to the first aspect, in a fifth possible implementation manner, the processing, according to the M and/or the N, an information stream to be grouped to obtain M groups of information streams to be sent includes: encoding the information stream to be grouped to obtain a bit stream, where the encoding includes Turbo code encoding, convolutional code encoding, or linear block code encoding, and the information stream to be grouped includes high-level check information; dividing the bit stream into M groups of bit streams to be modulated, where a length of the bit stream is C, and a length of each group of bit streams to be modulated is N; and modulating the M groups of bit streams to be modulated to obtain M groups of information streams to be sent.

With reference to the first aspect, in a sixth possible implementation manner, the processing, according to the M and/or the N, an information stream to be grouped to obtain M groups of information streams to be sent includes: encoding the information stream to be grouped to obtain a bit stream, where the encoding includes Turbo code encoding, convolutional code encoding, or linear block code encoding, and the information stream to be grouped includes high-level check information; modulating the bit stream to obtain a symbol stream; and dividing the symbol stream into M groups of information streams to be sent, where a length of the symbol stream is C, and a length of each group of information streams to be sent is N.

With reference to the first aspect or any one of the foregoing possible implementation manners, in a seventh possible implementation manner, the determining the number of groups M and/or a group size N includes: locally acquiring the preset number of the groups M and/or the group size N; or externally receiving the number of the groups M and/or the group size N.

With reference to the first aspect or any one of the foregoing possible implementation manners, in an eighth possible implementation manner, the determining the number of groups M and/or a group size N includes: determining the M according to the N and the C, or determining the N according to the M and the C:

$$M = ⌈ \frac{C}{N} ⌉$$

$$or$$

$$N = ⌈ \frac{C}{M} ⌉$$

where the C and N are in units of bits, or the C and N are in units of symbols, and ┌ ┐ is a round-up operation.

With reference to the first aspect or the seventh possible implementation manner of the first aspect, in a ninth possible implementation manner, the externally receiving the number of the groups M and/or the group size N includes: externally receiving a resource allocation message, where the resource allocation message is used to configure a time-frequency resource occupied by each group of the M groups of information streams to be sent.

With reference to the first aspect or the ninth possible implementation manner of the first aspect, in a tenth possible implementation manner, the resource allocation message includes at least one of the following items: the number of the groups M, the group size N, a time-domain size of the time-frequency resource occupied by each group, the number of resource blocks RBs and a modulation and coding scheme MCS, and the number of RBs and a transport block size TBS.

With reference to the first aspect, in an eleventh possible implementation manner, the sending, separately over M different time-frequency resources, the M groups of information streams to be sent includes: receiving, after a first group of the M groups of information streams to be sent is successfully sent, acknowledgment information sent by a base station, where the acknowledgment information is used to instruct that a current channel continues to be occupied in subsequent transmission.

With reference to the first aspect, in a twelfth possible implementation manner, the following is further included: receiving feedback for the M groups of information streams to be sent, or receiving feedback for each group of information streams to be sent.

In a second aspect, a method for receiving information is provided and includes: receiving M groups of symbol streams separately over M different time-frequency resources, where the number of symbols in each time-frequency resource of the M different time-frequency resources is greater than 4, and the M is an integer greater than 1; and processing the M groups of symbol streams to obtain an original information stream.

With reference to the second aspect, in a first possible implementation manner, the processing the M groups of symbol streams to obtain an original information stream includes: separately demodulating the M groups of symbol streams to obtain M groups of bit streams, where a length of the bit streams is C, and a length of each group of bit streams is N; merging the M groups of bit streams into a bit stream to be decoded; decoding the bit stream to be decoded to obtain the original information stream, where the decoding includes Turbo code decoding or convolutional code decoding; and checking the original information stream.

With reference to the second aspect, in a second possible implementation manner, the processing the M groups of symbol streams to obtain an original information stream includes: merging the M groups of symbol streams into a symbol stream to be demodulated, where a length of the symbol stream to be demodulated is C, and a length of each group of symbol streams is N; demodulating the symbol stream to be demodulated to obtain a bit stream to be decoded; decoding the bit stream to be decoded to obtain the original information stream, where the decoding includes Turbo code decoding or convolutional code decoding; and checking the original information stream.

With reference to the second aspect, in a third possible implementation manner, the processing the M groups of symbol streams to obtain an original information stream includes: separately demodulating the M groups of symbol streams to obtain M groups of bit streams to be decoded; separately performing linear block code decoding on the M groups of bit streams to be decoded to obtain M groups of bit streams; merging the M groups of bit streams into the original information stream, where a length of the original information stream is C, and a length of each group of bit streams is N; and checking the original information stream.

With reference to the second aspect or the first and the second possible implementation manners of the second aspect, in a fourth possible implementation manner, the checking the original information stream includes: cyclic redundancy check or high-level check information check; and the decoding further includes: linear block code decoding.

With reference to the second aspect or any one of the foregoing possible implementation manners, in a fifth possible implementation manner, determining the number of groups M and/or a group size N is further included, including: determining the M according to the N and the C, or determining the N according to the M and the C:

$$M = ⌈ \frac{C}{N} ⌉$$

$$or$$

$$N = ⌈ \frac{C}{M} ⌉$$

where the C and N are in units of bits, or the C and N are in units of symbols, the N is an integer greater than 1 or equal to 1, and ┌ ┐ is a round-up operation.

With reference to the second aspect or the fifth possible implementation manner of the second aspect, in a sixth possible implementation manner, the following is further included: determining and sending a resource allocation message, where the resource allocation message is used to configure a time-frequency resource occupied by each group of the M groups of symbol streams.

With reference to the second aspect or the sixth possible implementation manner of the second aspect, in a seventh possible implementation manner, the resource allocation message includes at least one of the following items: the number of the groups M, the group size N, a time-domain size of the time-frequency resource occupied by each group, the number of resource blocks RBs and a modulation and coding scheme MCS, and the number of RBs and a transport block size TBS.

With reference to the second aspect, in an eighth possible implementation manner, the receiving M groups of symbol streams separately over M different time-frequency resources includes: sending acknowledgment information to a user equipment after a first group of the M groups of symbol streams is successfully received, where the acknowledgment information is used to instruct that a current channel continues to be occupied in subsequent transmission.

With reference to the second aspect, in a ninth possible implementation manner, the following is further included: sending feedback for the M groups of symbol streams; or sending feedback for each group of symbol streams.

In a third aspect, a device for sending information is provided and includes: a determining unit, configured to determine the number of groups M and/or a group size N, where the M is an integer greater than 1, and the N is an integer greater than 1 or equal to 1; a processing unit, configured to process, according to the M and/or the N, an information stream to be grouped to obtain M groups of information streams to be sent; and a sending unit, configured to send, separately over M different time-frequency resources, the M groups of information streams to be sent, where the number of symbols in each time-frequency resource of the M different time-frequency resources is greater than 4.

With reference to the third aspect, in a first possible implementation manner, the device for sending information further includes an encoding unit and a modulation unit, and the processing unit is specifically configured to: add a cyclic redundancy check code behind the information stream to be grouped; encode, by using the encoding unit, the information stream to be grouped to obtain a bit stream, where the information stream to be grouped is added with the cyclic redundancy check code, and the encoding includes Turbo code encoding or convolutional code encoding; divide the bit stream into M groups of bit streams to be modulated, where a length of the bit stream is C, and a length of each group of bit streams to be modulated is N; and separately modulate, by using the modulation unit, the M groups of bit streams to be modulated to obtain M groups of information streams to be sent.

With reference to the third aspect, in a second possible implementation manner, the device for sending information further includes an encoding unit and a modulation unit, and the processing unit is specifically configured to: add a cyclic redundancy check code behind the information stream to be grouped; encode, by using the encoding unit, the information stream to be grouped to obtain a bit stream, where the information stream is added with the cyclic redundancy check code, and the encoding includes Turbo code encoding or convolutional code encoding; modulate the bit stream by using the modulation unit to obtain a symbol stream; and divide the symbol stream into M groups of information streams to be sent, where a length of the symbol stream is C, and a length of each group of information streams to be sent is N.

With reference to the third aspect, in a third possible implementation manner, the device for sending information further includes an encoding unit and a modulation unit, and the processing unit is specifically configured to: divide the information stream to be grouped into M groups of information streams to be encoded, where a length of the information stream to be grouped is C, and a length of each group of information streams to be encoded is N; separately perform, by using the encoding unit, linear bock code encoding on the M groups of information streams to be encoded to obtain M groups of bit streams; and separately modulate the M groups of bit streams by using the modulation unit to obtain M groups of information streams to be sent.

With reference to the third aspect, in a fourth possible implementation manner, the device for sending information further includes an encoding unit and a modulation unit, and the processing unit is specifically configured to: divide the information stream to be grouped into M groups of information streams to be encoded, where a length of the information stream to be grouped is C, a length of each group of information streams to be encoded is N, and the information stream to be grouped includes high-level check information; encode, by using the encoding unit, the M groups of information streams to be encoded to obtain M groups of bit streams, where the encoding includes Turbo code encoding, convolutional code encoding, or linear block code encoding; and modulate the M groups of bit streams by using the modulation unit to obtain M groups of information streams to be sent.

With reference to the third aspect, in a fifth possible implementation manner, the device for sending information further includes an encoding unit and a modulation unit, and the processing unit is specifically configured to: encode, by using the encoding unit, the information stream to be grouped to obtain a bit stream, where the encoding includes Turbo code encoding, convolutional code encoding, or linear block code encoding, and the information stream to be grouped includes high-level check information; divide the bit stream into M groups of bit streams to be modulated, where a length of the bit stream is C, and a length of each group of bit streams to be modulated is N; and modulate, by using the modulation unit, the M groups of bit streams to be modulated to obtain M groups of information streams to be sent.

With reference to the third aspect, in a sixth possible implementation manner, the device for sending information further includes an encoding unit and a modulation unit, and the processing unit is specifically configured to: encode, by using the encoding unit, the information stream to be grouped to obtain a bit stream, where the encoding includes Turbo code encoding, convolutional code encoding, or linear block code encoding, and the information stream to be grouped includes high-level check information; modulate the bit stream by using the modulation unit to obtain a symbol stream; and divide the symbol stream into M groups of information streams to be sent, where a length of the symbol stream is C, and a length of each group of information streams to be sent is N.

With reference to the third aspect or any one of the foregoing possible implementation manners, in a seventh possible implementation manner, the device for sending information further includes a receiving unit, and the determining unit is specifically configured to: locally acquire the preset number of the groups M and/or the group size N; or externally receive the number of the groups M and/or the group size N by using the receiving unit.

With reference to the third aspect or any one of the foregoing possible implementation manners, in an eighth possible implementation manner, the determining unit is specifically configured to: determine the M according to the N and the C, or determine the N according to the M and the C:

$$M = ⌈ \frac{C}{N} ⌉$$

$$or$$

$$N = ⌈ \frac{C}{M} ⌉$$

where the C and N are in units of bits, or the C and N are in units of symbols, and ┌ ┐ is a round-up operation.

With reference to the third aspect or the seventh possible implementation manner of the third aspect, in a ninth possible implementation manner, the receiving unit is specifically configured to: externally receive a resource allocation message, where the resource allocation message is used to configure a time-frequency resource occupied by each group of the M groups of information streams to be sent.

With reference to the third aspect or the ninth possible implementation manner of the third aspect, in a tenth possible implementation manner, the resource allocation message includes at least one of the following items: the number of the groups M, the group size N, a time-domain size of the time-frequency resource occupied by each group, the number of resource blocks RBs and a modulation and coding scheme MCS, and the number of RBs and a transport block size TBS.

With reference to the third aspect, in an eleventh possible implementation manner, the receiving unit is specifically configured to: receive acknowledgment information sent by a base station after a first group of the M groups of information streams to be sent is successfully sent, where the acknowledgment information is used to instruct that a current channel continues to be occupied in subsequent transmission.

With reference to the third aspect, in a twelfth possible implementation manner, the receiving unit is further configured to:

receive feedback for the M groups of information streams to be sent; or,

receive feedback for each group of information streams to be sent.

In a fourth aspect, a device for receiving information is provided and includes: a receiving unit, configured to receive M groups of symbol streams separately over M different time-frequency resources, where the number of symbols in each time-frequency resource of the M different time-frequency resources is greater than 4, and the M is an integer greater than 1; and a processing unit, configured to process the M groups of symbol streams to obtain an original information stream.

With reference to the fourth aspect, in a first possible implementation manner, the device for receiving information further includes a demodulation unit and a decoding unit, and the processing unit is specifically configured to: separately demodulate the M groups of symbol streams by using the demodulation unit to obtain M groups of bit streams, where a length of the bit streams is C, and a length of each group of bit streams is N; merge the M groups of bit streams into a bit stream to be decoded; decode, by using the decoding unit, the bit stream to be decoded to obtain the original information stream, where the decoding includes Turbo code decoding or convolutional code decoding; and check the original information stream.

With reference to the fourth aspect, in a second possible implementation manner, the device for receiving information further includes a demodulation unit and a decoding unit, and the processing unit is specifically configured to: merge the M groups of symbol streams into a symbol stream to be demodulated, where a length of the symbol stream to be demodulated is C, and a length of each group of symbol streams is N; demodulate, by using the demodulation unit, the symbol stream to be demodulated to obtain a bit stream to be decoded; decode, by using the decoding unit, the bit stream to be decoded to obtain the original information stream, where the decoding includes Turbo code decoding or convolutional code decoding; and check the original information stream.

With reference to the fourth aspect, in a third possible implementation manner, the device for receiving information further includes a demodulation unit and a decoding unit, and the processing unit is specifically configured to: separately demodulate the M groups of symbol streams by using the demodulation unit to obtain M groups of bit streams to be decoded; separately perform, by using the decoding unit, linear block code decoding on the M groups of bit streams to be decoded to obtain M groups of bit streams; merge the M groups of bit streams into the original information stream, where a length of the original information stream is C, and a length of each group of bit streams is N; and check the original information stream.

With reference to the fourth aspect or the first and the second possible implementation manners of the fourth aspect, in a fourth possible implementation manner, the checking the original information stream includes: cyclic redundancy check or high-level check information check; and the decoding further includes: linear block code decoding.

With reference to the fourth aspect or any one of the foregoing possible implementation manners, in a fifth possible implementation manner, the device for receiving information further includes a determining unit, where the determining unit is specifically configured to: determine the M according to the N and the C, or determine the N according to the M and the C:

$$M = ⌈ \frac{C}{N} ⌉$$

$$or$$

$$N = ⌈ \frac{C}{M} ⌉$$

where the C and N are in units of bits, or the C and N are in units of symbols, N is an integer greater than 1 or equal to 1, and ┌ ┐ is a round-up operation.

With reference to the fourth aspect or the fifth possible implementation manner of the fourth aspect, in a sixth possible implementation manner, the device for receiving information further includes a sending unit, configured to: determine a resource allocation message by using the determining unit and send the resource allocation message, where the resource allocation message is used to configure a time-frequency resource occupied by each group of the M groups of symbol streams.

With reference to the fourth aspect or the sixth possible implementation manner of the fourth aspect, in a seventh possible implementation manner, the resource allocation message includes at least one of the following items: the number of the groups M, the group size N, a time-domain size of the time-frequency resource occupied by each group, the number of resource blocks RBs and a modulation and coding scheme MCS, and the number of RBs and a transport block size TBS.

With reference to the fourth aspect, in an eighth possible implementation manner, the sending unit is further configured to: send acknowledgment information to a user equipment after a first group of the M groups of symbol streams is successfully received, where the acknowledgment information is used to instruct that a current channel continues to be occupied in subsequent transmission.

With reference to the fourth aspect, in a ninth possible implementation manner, the sending unit is further configured to: send feedback for the M groups of symbol streams; or send feedback for each group of symbol streams.

Based on the foregoing technical solutions, in a case of a low code rate, by grouping an information stream to be sent, transmission efficiency and transmission quality are ensured in the embodiments of the present invention.

### BRIEF DESCRIPTION OF THE DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a flowchart of a method for sending information according to an embodiment of the present invention;

FIG. 2 is a flowchart of a method for sending information according to another embodiment of the present invention;

FIG. 3 is a flowchart of a method for sending information according to another embodiment of the present invention;

FIG. 4 is a flowchart of a method for sending information according to another embodiment of the present invention;

FIG. 5 is a flowchart of a method for receiving information according to an embodiment of the present invention;

FIG. 6 is a schematic block diagram of a device for sending information according to an embodiment of the present invention;

FIG. 7 is a schematic block diagram of a device for receiving information according to an embodiment of the present invention;

FIG. 8 is a schematic block diagram of a device for sending information according to another embodiment of the present invention; and

FIG. 9 is a schematic block diagram of a device for receiving information according to another embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

The technical solutions of the present invention may be applied to various communications systems, such as a Global System for Mobile Communications (GSM), a Code Division Multiple Access (CDMA) system, a Wideband Code Division Multiple Access (WCDMA) system, a General Packet Radio Service (GPRS) system, and a Long Term Evolution (LTE) system.

A user equipment (UE) may also be called a mobile terminal, a mobile user equipment, or the like. It is capable of communicating with one or more core networks by using a radio access network (for example, Radio Access Network, RAN). The user equipment may be a mobile terminal, such as a mobile phone (or called a “cellular” phone) and a computer having a mobile terminal, for example, may be a portable, pocket-sized, handheld, computer-embedded, or vehicle-mounted mobile apparatus, which exchanges voice and/or data with the radio access network.

A base station may be a GSM or CDMA base transceiver station (BTS), a WCDMA base station (NodeB), or an LTE evolved base station (eNB, or evolved Node B, e-NodeB), which is not limited in the present invention.

In the technical solutions of the present invention, for ease of description, a UE is used as a device for sending information, and a base station is used as a device for receiving information. It should be understood that the device for sending information and the device for receiving information may be any two machine-to-machine (M2M) devices performing machine-type communication (MTC), or may be a base station and a user equipment, where the user equipment may be an M2M terminal, which is not limited in the present invention.

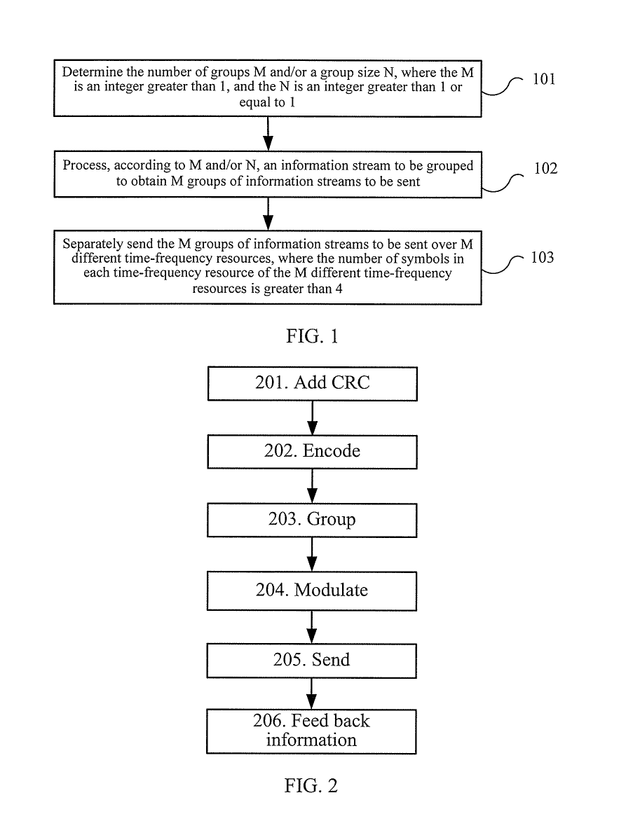

FIG. 1 is a flowchart of a method for sending information according to an embodiment of the present invention.

101. Determine the number of groups M and/or a group size N, where the M is an integer greater than 1, and the N is an integer greater than 1 or equal to 1.

A UE may locally acquire the preset number of the groups M and/or the group size N, or may receive the number of the groups M and/or the group size N from an external device (from a serving base station); and a length of an information stream to be sent is C. M may be determined according to N and C, or N may be determined according to M and C:

$$M = ⌈ \frac{C}{N} ⌉$$

$$or$$

$$N = ⌈ \frac{C}{M} ⌉$$

where the C and N are in units of bits, or the C and N are in units of symbols, and ┌ ┐ is a round-up operation.

102. Process, according to M and/or N, an information stream to be grouped to obtain M groups of information streams to be sent.

The processing may include adding a check code, encoding, modulating, and grouping. A specific sequence and a combination are described in an embodiment. For a grouping process, grouping may be performed according to a relational expression between M, N, and C in step 101, according to M only, according to N only, or according to M and N.

103. Separately send the M groups of information streams to be sent over M different time-frequency resources, where the number of symbols in each time-frequency resource of the M different time-frequency resources is greater than 4.

Sending of the M groups of information streams to be sent may be based on scheduling, or may be based on contention. In a scheduling-based case, a base station needs to deliver configuration information to configure a time-frequency resource. The number of OFDM symbols in each time-frequency resource is greater than 4, and a greater number of OFDM symbols included in a unit time-domain resource indicates wider coverage.

Based on the foregoing technical solution, in a case of a low code rate, by grouping an information stream to be sent, transmission efficiency is ensured in this embodiment of the present invention.

Optionally, as an embodiment, in step 102, the processing an information stream to be grouped may include: adding a cyclic redundancy check code behind the information stream to be grouped; encoding the information stream to be grouped to obtain a bit stream, where the information stream to be grouped is added with the cyclic redundancy check code, and the encoding includes Turbo code encoding or convolutional code encoding; dividing the bit stream into M groups of bit streams to be modulated, where a length of the bit stream is C, and a length of each group of bit streams to be modulated is N; and separately modulating the M groups of bit streams to be modulated to obtain M groups of information streams to be sent.

Optionally, as another embodiment, in step 102, the processing an information stream to be grouped may include: adding a cyclic redundancy check code behind the information stream to be grouped; encoding the information stream to be grouped to obtain a bit stream, where the information stream to be grouped is added with the cyclic redundancy check code, and the encoding includes Turbo code encoding or convolutional code encoding; modulating the bit stream to obtain a symbol stream; and dividing the symbol stream into M groups of information streams to be sent, where a length of the symbol stream is C, and a length of each group of information streams to be sent is N.

Optionally, as another embodiment, in step 102, the processing an information stream to be grouped may include: dividing the information stream to be grouped into M groups of information streams to be encoded, where a length of the information stream to be grouped is C, and a length of each group of information streams to be encoded is N; performing linear block code encoding on the M groups of information streams to be encoded to obtain M groups of bit streams; and separately modulating the M groups of bit streams to obtain M groups of information streams to be sent.

Optionally, as another embodiment, in step 102, the processing an information stream to be grouped may include: dividing the information stream to be grouped into M groups of information streams to be encoded, where a length of the information stream to be grouped is C, a length of each group of information streams to be encoded is N, and the information stream to be grouped includes high-level check information; encoding the M groups of information streams to be encoded to obtain M groups of bit streams, where the encoding includes Turbo code encoding, convolutional code encoding, or linear block code encoding; and modulating the M groups of bit streams to obtain M groups of information streams to be sent.

Optionally, as another embodiment, in step 102, the processing an information stream to be grouped may include: encoding the information stream to be grouped to obtain a bit stream, where the encoding includes Turbo code encoding, convolutional code encoding, or linear block code encoding, and the information stream to be grouped includes high-level check information; dividing the bit stream into M groups of bit streams to be modulated, where a length of the bit stream is C, and a length of each group of bit streams to be modulated is N; and modulating the M groups of bit streams to be modulated to obtain M groups of information streams to be sent.

Optionally, as another embodiment, in step 102, the processing an information stream to be grouped may include: encoding the information stream to be grouped to obtain a bit stream, where the encoding includes Turbo code encoding, convolutional code encoding, or linear block code encoding, and the information stream to be grouped includes high-level check information; modulating the bit stream to obtain a symbol stream; and dividing the symbol stream into M groups of information streams to be sent, where a length of the symbol stream is C, and a length of each group of information streams to be sent is N.

Optionally, as another embodiment, in a scheduling-based case, a resource allocation message may be received externally, where the resource allocation message is used to configure a time-frequency resource occupied by each group of the M groups of information streams to be sent. The resource allocation message includes at least one of the following items: the number of groups M, a group size N, a time-domain size of the time-frequency resource occupied by each group, the number of resource blocks RBs and a modulation and coding scheme MCS, and the number of RBs and a transport block size TBS.

Optionally, as another embodiment, in a contention-based case, after a first group of the M groups of information streams to be sent is successfully sent, acknowledgment information sent by a base station is received, where the acknowledgment information is used to instruct that a current channel continues to be occupied in subsequent transmission.

Optionally, as another embodiment, a UE may receive feedback for the M groups of information streams to be sent, or receive feedback for each group of information streams to be sent.

Therefore, in a case of a low code rate, by grouping an information stream to be sent, and transmission efficiency is ensured in this embodiment of the present invention. In addition, in a manner of sharing a check code or using linear block code encoding, overhead is saved, and simultaneously coverage is improved.

FIG. 2 is a flowchart of a method for sending information according to another embodiment of the present invention. FIG. 2 is a specific embodiment of FIG. 1.

201. Add cyclic redundancy check CRC.

A sender needs to send an information stream a₀, a₁, a₂, a₃, . . . , a_{A-1} at a physical layer, where a length of the information stream is A. First, one CRC needs to be added to the information stream, so that the information stream becomes b₀, b₁, b₂, b₃, . . . , b_{B-1}, and a length of the information stream added with the CRC is B. That is, B=A+L, where L is a length of the CRC, and CRC check bits may be p₀, p₁, p₂, p₃, . . . , p_{L-1}. Generally, L=8, 16, 24. The CRC is generated by using the following polynomials, where D is a symbol, and D³ represents a cubic term:

when L=24, polynomials are as follows:

g_{CRC24A}(D)=[D²⁴+D²³+D¹⁸+D¹⁷+D¹⁴+D¹¹+D¹⁰+D⁷+D⁶+D⁵+D⁴+D³+D+1]

g_{CRC24B}(D)=[D²⁴+D²³+D⁶+D⁵+D+1]

when L=16, a polynomial is as follows:

g_{CRC16}(D)=[D¹⁶+D¹²+D⁵+1]

when L=8, a polynomial is as follows:

g_{CRC8}(D)=[D⁸+D⁷+D⁴+D³+D+1]

where p₀, p₁, p₂, p₃, . . . , p_{B-1}, meets the following equations:

a remainder of a₀D^{A+23}+a₁D^{A+22}+ . . . +a_{A-1}D²⁴+p₀D²³+p₁D²²+ . . . +p₂₂D¹+p₂₃ divided by the polynomial g_{CRC24A}(D) or g_{CRC24B}(D) when L=24 is 0;

a remainder of a₀D^{A+15}+a₁D^{A+14}+ . . . +a_{A-1}D¹⁶+p₀D¹⁵+p₁D¹⁴+ . . . +p₁₄D¹+p₁₅ divided by the polynomial g_{CRC16}(D) when L=16 is 0; and

a remainder of a₀D^{A+7}+a₁D^{A+6}+ . . . +a_{A-1}D⁸+p₀D⁷+p₁D⁶+ . . . +p₆D¹+p₇ divided by the polynomial g_{CRC8}(D) when L=8 is 0;

where a relationship between aₖ and bₖ is:

bₖ=aₖ where k=0,1,2, . . . , A−1

bₖ=p_{k-A} where k=A,A+1,A+2, . . . , A+L−1

202. Perform Encoding.

The information stream added with the CRC is encoded by using an encoder, where the encoder may be a Turbo encoder, such as a ⅓ Turbo encoder, or a convolutional code encoder, such as a ⅓ convolutional code encoder.

203. Perform Grouping.

First, the number of groups M or a group size N needs to be determined, or both M and N need to be determined. Specifically, M and N may be preset values, may be directly acquired by a UE locally, or a base station may notify the UE of M and N by using signaling. A length of a bit stream after the encoding in step 202 is C. The number of the groups M, the group size N, and C meet the following relationship:

$$M = ⌈ \frac{C}{N} ⌉$$

$$or$$

$$N = ⌈ \frac{C}{M} ⌉$$

In this embodiment, an information stream to be grouped is an encoded bit stream, and therefore the C and N are in units of bits; and ┌ ┐ is a round-up operation. According to the foregoing relational expression, N may be determined according to M and C; or M may be determined according to N and C. C is known, that is, the bit stream may be grouped by acquiring either M or N. The number of bits included in each group is N, where N is divisible by a modulation order so that modulation can be performed in the next step.

204. Perform Modulation.

A modulation scheme may be predefined, or the base station may notify the UE of the modulation scheme by using signaling. Table 1 lists part of correspondence between a modulation and coding scheme index I_{MCS}, a modulation order Qₘ, and a transport block index I_{TBS} of a data channel. The UE may learn the modulation and coding scheme index I_{MCS} from downlink control information (Downlink Control Information, DCI) delivered by the base station, and may determine the modulation scheme, the modulation order Qₘ, and the transport block index I_{TBS} by querying the table.

TABLE 1
MCS

| Modulation and Coding | | Transport Block |
|---|---|---|
| Scheme Index I_{MCS} | Modulation Order Qₘ | Index I_{TBS} |
| 0 | 2 | 0 |
| 1 | 2 | 1 |
| 2 | 2 | 2 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 4 | 9 |
| 11 | 4 | 10 |
| 12 | 4 | 11 |
| 13 | 4 | 12 |
| 14 | 4 | 13 |
| 15 | 4 | 14 |
| 16 | 4 | 15 |
| 17 | 6 | 15 |
| 18 | 6 | 16 |
| 19 | 6 | 17 |
| 20 | 6 | 18 |

For example, it is assumed that the base station notifies that the coding scheme index I_{MCS} is 4, it is known by querying the table that QPSK2 modulation is used, and the transport block index I_{TBS} is 4 and may further be used to query a TBS table to obtain a transport block size.

The following lists part of a table of correspondence between the transport block size, the number of physical resource blocks N_{PRB}, and the transport block index I_{TBS}:

TABLE 2
TBS table

| | The Number of Physical Resource Blocks N_{PRB} | | | | | | | | | |
|---|---|---|---|---|---|---|---|---|---|---|
| I_{TBS} | 1 | 2 | 3 | 4 | 5 | 6 | 7 | 8 | 9 | 10 |
| 0 | 16 | 32 | 56 | 88 | 120 | 152 | 176 | 208 | 224 | 256 |
| 1 | 24 | 56 | 88 | 144 | 176 | 208 | 224 | 256 | 328 | 344 |
| 2 | 32 | 72 | 144 | 176 | 208 | 256 | 296 | 328 | 376 | 424 |
| 3 | 40 | 104 | 176 | 208 | 256 | 328 | 392 | 440 | 504 | 568 |
| 4 | 56 | 120 | 208 | 256 | 328 | 408 | 488 | 552 | 632 | 696 |
| 5 | 72 | 144 | 224 | 328 | 424 | 504 | 600 | 680 | 776 | 872 |
| 6 | 328 | 176 | 256 | 392 | 504 | 600 | 712 | 808 | 936 | 1032 |
| 7 | 104 | 224 | 328 | 472 | 584 | 712 | 840 | 968 | 1096 | 1224 |
| 8 | 120 | 256 | 392 | 536 | 680 | 808 | 968 | 1096 | 1256 | 1384 |
| 9 | 136 | 296 | 456 | 616 | 776 | 936 | 1096 | 1256 | 1416 | 1544 |
| 10 | 144 | 328 | 504 | 680 | 872 | 1032 | 1224 | 1384 | 1544 | 1736 |

According to the transport block index I_{TBS} queried from Table 1 and the number of physical resource blocks N_{PRB} acquired by using the DCI, a corresponding transport block size TBS may be known.

The following describes an example of step 201 to step 204. It is assumed that a length of an original information stream is 136 bits; a 24-bit CRC is added after the information stream to form a bit stream of 160 bits; and then, the bit stream is encoded, for example, ⅓ convolutional code encoding is used, so that a length of the encoded bit stream becomes 480 bits, that is, C=480. According to a notification of the base station or a predefinition, it is determined that the number of the groups M is 20; that is, the bit stream C is equidistantly divided into 20 groups, and the number of bits in each group is:

N=┌(136+24)×3/20┐=24bit

The UE determines a modulation scheme and a modulation order, for example, QPSK2, according to a DCI notification or a preset value, and after modulation, M groups of symbol streams (information streams to be sent) are obtained, where each group includes 12 QPSK symbols. Herein, because only one CRC is added to the original information stream, equivalent to 20 groups of encoded and modulated information streams sharing one CRC, overhead is saved in a case of a low code rate.

205. Perform Sending.

After grouping, the M groups of symbol streams need to be sent separately over M different time-frequency resources. A time-frequency resource includes a time resource (that is, M), where the M is at least greater than 1, may be equal to 1 to be compatible with the prior art (no grouping), or may be a multiple of 4 such as 4 ms or 8 ms, so as to reuse an HARQ process in a case of TTI bundling. For example, M=4, four transmission resources correspond to RB#4-5 of subframe #1, RB#2-3 of subframe #2, RB#15-16 of subframe #3, and RB#30-31 of subframe #4, respectively, where the time resources may be continuous or discontinuous. A length of a time resource may be notified by signaling or may be predefined; for example, a predefined size of a time domain is 16.

In a scheduling-based case, allocation of time-frequency resources may be determined by a base station and delivered to a UE by using signaling. Specifically, as an example, the base station may allocate all M groups of transmission resources by using DCI, where the DCI may include the number of RBs (PRB), a new MCS or an original MCS (or a new TBS), and value M or value N, and may further include a size of a time domain of a transmission resource.

In a contention-based case, the UE may first send a code, for example, an access code; this code may carry some information, for example, multiple time-frequency resources, for example, M, that the user needs to occupy; after successfully receiving the access code, the base station delivers acknowledgment information; and then the user continues to occupy a certain channel, until the transmission is completed. The occupied channel may be allocated by the base station, where information about the channel information is carried in the acknowledgment information; or may be a corresponding channel of the access code and/or a channel in which the access code is located. In a last transmission after the grouping, a feature may be added, for example, a certain spreading factor such as (1,−1) is used over a pilot, or a string of all-special symbols, such as <NULL> frequently used in LTE, is added after encoded data, to indicate to a receiver that the transmission is completed.

206. Feed Back Information.

Because only one CRC is added to the uncoded original information stream corresponding to the M groups of bit streams, only after the receiver receives all M groups of information streams, can the received information streams be checked as a whole according to the CRC and be fed back. That is, after all the M groups of information streams are received, an ACK/NACK is fed back. It should be understood that feedback is not limited to an ACK/NACK and is not limited in the present invention.

Therefore, in a case of a low code rate, by grouping an information stream to be sent, transmission efficiency is ensured in this embodiment of the present invention. In addition, in a manner of CRC sharing, overhead is saved, encoding performance is improved, and a coverage range is expanded.

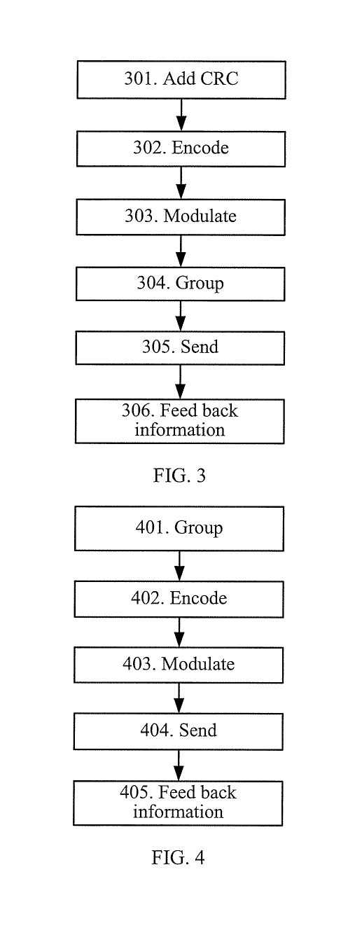

FIG. 3 is a flowchart of a method for sending information according to another embodiment of the present invention.

301. Add CRC.

A sender needs to send an information stream a₀, a₁, a₂, a₃, . . . , a_{A-1} at a physical layer, where a length of the information stream is A. First, one CRC needs to be added to the information stream, so that the information stream becomes b₀, b₁, b₂, b₃, . . . , b_{B-1}, and a length of the information stream added with the CRC is B. That is, B=A+L, where L is a length of the CRC, and CRC check bits may be p₀, p₁, p₂, p₃, . . . , p_{L-1}. Generally, L=8, 16, 24. For a specific method for generating a CRC, reference may be made to step 201 in FIG. 2, and details are not described herein again.

A relationship between aₖ and bₖ is:

bₖ=aₖ where k=0,1,2, . . . , A−1

bₖ=p_{k-A} where k=A,A+1,A+2, . . . , A+L−1

302. Perform Encoding.

The information stream added with the CRC is encoded by using an encoder, where the encoder may be a Turbo encoder, such as a ⅓ Turbo encoder, or a convolutional code encoder, such as a ⅓ convolutional code encoder.

303. Perform Modulation.

A modulation scheme may be predefined, or a base station may notify a UE of the modulation scheme by using signaling. Table 1 in step 204 lists correspondence between a modulation and coding scheme index I_{MCS}, a modulation order Qₘ, and a transport block index I_{TBS} of a data channel. The UE may learn the modulation and coding scheme index I_{MCS} from downlink control information (Downlink Control Information, DCI) delivered by the base station, and may determine the modulation scheme, the modulation order Qₘ, and the transport block index I_{TBS} by querying the table.

304. Perform Grouping.

First, the number of groups M or a group size N needs to be determined, or both M and N need to be determined. Specifically, M and N may be preset values, may be directly acquired by a UE locally, or a base station may notify the UE of M and N by using signaling. A length of a symbol stream after modulation in step 303 is C. The number of the groups M, the group size N, and C satisfy the following relationship:

$$M = ⌈ \frac{C}{N} ⌉$$

$$or$$

$$N = ⌈ \frac{C}{M} ⌉$$

In this embodiment, an information stream to be grouped is a modulated symbol stream, and therefore the C and N are in units of symbols; and ┌ ┐ is a round-up operation. According to the foregoing relational expression, N may be determined according to M and C, and M may also be determined according to N and C. C is known, that is, the symbol stream may be grouped by acquiring either M or N. The number of symbols included in each group is N, and N is greater than 4.

The following describes an example of step 301 to step 304. It is assumed that a length of an original information stream is 136 bits; a 24-bit CRC is added after the information stream to form a bit stream of 160 bits; and then, the bit stream is encoded, for example, ⅓ convolutional code encoding is used, so that a length of the encoded bit stream becomes 480 bits. The UE determines a modulation scheme and a modulation order, for example, QPSK2, according to a DCI message or a preset value, and after modulation, a symbol stream of 240 symbols (information stream to be grouped), that is, C=240, is obtained. According to a notification of the base station or a predefinition, it is determined that the number of the groups M is 20; that is, the symbol stream C is equidistantly divided into 20 groups, and the number of symbols in each group is:

N=┌(136+24)×3/2/20┐=12symbol

That is, each group includes 12 QPSK symbols. Herein, because only one CRC is added to the original information stream, equivalent to 20 groups of encoded and modulated information streams sharing one CRC, overhead is saved in a case of a low code rate.

305. Perform Sending.

After grouping, the M groups of symbol streams need to be sent separately over M different time-frequency resources. A time-frequency resource includes a time resource (that is, M), where the M is at least greater than 1, may be equal to 1 to be compatible with the prior art (no grouping), or may be a multiple of 4 such as 4 ms or 8 ms, so as to reuse an HARQ process in a case of TTI bundling. For example, M=4, four transmission resources correspond to RB#4-5 of subframe #1, RB#2-3 of subframe #2, RB#15-16 of subframe #3, and RB#30-31 of subframe #4, respectively, where the time resources may be continuous or discontinuous. A size of a time resource may be notified by signaling or may be predefined; for example, a predefined size of a time domain is 16.

In a scheduling-based case, allocation of time-frequency resources may be determined by a base station and delivered to a UE by using signaling. Specifically, as an example, the base station may allocate all M groups of transmission resources by using DCI, where the DCI may include the number of RBs (PRB), a new MCS or an original MCS (or a new TBS), and value M or value N, and may further include a size of a time domain of a transmission resource.

In a contention-based case, the UE may first send a code, for example, an access code; this code may carry some information, for example, multiple time-frequency resources, for example, M, that the user needs to occupy; after successfully receiving the access code, the base station delivers acknowledgment information; and then the user continues to occupy a channel, until the transmission is completed. The occupied channel may be allocated by the base station, where information about the channel information is carried in the acknowledgment information; or may be a corresponding channel of the access code and/or a channel in which the access code is located. In a last transmission after the grouping, a feature may be added, for example, a spreading factor such as (1,−1) is used over a pilot, or a string of all-special symbols, such as <NULL> frequently used in LTE, is added after encoded data, to indicate to a receiver that the transmission is completed.

306. Feed Back Information.

Because only one CRC is added to the uncoded original information stream corresponding to the M groups of bit streams, only after the receiver receives all M groups of information streams, can the received information streams be checked as a whole according to the CRC and be fed back. That is, after all the M groups of information streams are received, an ACK/NACK is fed back. It should be understood that feedback is not limited to an ACK/NACK and is not limited in the present invention.

Therefore, in a case of a low code rate, by grouping an information stream to be sent, transmission efficiency is ensured in this embodiment of the present invention. In addition, in a manner of CRC sharing, overhead is saved, and encoding performance is improved.

FIG. 4 is a flowchart of a method for sending information according to another embodiment of the present invention.

401. Perform Grouping.

A sender needs to send an information stream C at a physical layer, and the information stream is grouped before encoding. First, the number of groups M or a group size N needs to be determined, or both M and N need to be determined. Specifically, M and N may be preset values, may be directly acquired by a UE locally, or a base station may notify the UE of M and N by using signaling. The number of the groups M, the group size N, and C satisfy the following relationship:

$$M = ⌈ \frac{C}{N} ⌉$$

$$or$$

$$N = ⌈ \frac{C}{M} ⌉$$

In this embodiment, an information stream to be grouped is an uncoded bit stream, and therefore the C and N are in units of bits; and ┌ ┐ is a round-up operation. According to the foregoing relational expression, N may be determined according to M and C, and M may also be determined according to N and C. C is known, that is, the bit stream may be grouped by acquiring either M or N; and the number of bits included in each group is N.

402. Perform Encoding.

After an original information stream is grouped, linear block code encoding is separately performed on each group of information streams, for example, RM (Reed-Muller) encoding, where a corresponding matrix of the RM encoding may be Table 3, and A is the number of original information bits. It is assumed that the original information bit stream is a₀, a₁, a₂, a₃, . . . , a_{A-1} and becomes b₀, b₁, b₂, b₃, . . . , b_{B-1} after encoding, where

$${b}_{i} = {\sum }_{n = 0}^{A - 1} ( {a}_{n} \cdot {M}_{i , n} ) mod 2 ,$$

and i=0, 1, 2, . . . , B−1

When B=32, Table 3 is used; and when B is another value, a corresponding (B, O) table is used for encoding.

TABLE 3
Basis sequences for (32, O) codes

| i | M_{i, 0} | Mi_{i, 1} | M_{i, 2} | M_{i, 3} | M_{i, 4} | M_{i, 5} | M_{i, 6} | M_{i, 7} | M_{i, 8} | M_{i, 9} | M_{i, 10} |
|---|---|---|---|---|---|---|---|---|---|---|---|
| 0 | 1 | 1 | 0 | 0 | 0 | 0 | 0 | 0 | 0 | 0 | 1 |
| 1 | 1 | 1 | 1 | 0 | 0 | 0 | 0 | 0 | 0 | 1 | 1 |
| 2 | 1 | 0 | 0 | 1 | 0 | 0 | 1 | 0 | 1 | 1 | 1 |
| 3 | 1 | 0 | 1 | 1 | 0 | 0 | 0 | 0 | 1 | 0 | 1 |
| 4 | 1 | 1 | 1 | 1 | 0 | 0 | 0 | 1 | 0 | 0 | 1 |
| 5 | 1 | 1 | 0 | 0 | 1 | 0 | 1 | 1 | 1 | 0 | 1 |
| 6 | 1 | 0 | 1 | 0 | 1 | 0 | 1 | 0 | 1 | 1 | 1 |
| 7 | 1 | 0 | 0 | 1 | 1 | 0 | 0 | 1 | 1 | 0 | 1 |
| 8 | 1 | 1 | 0 | 1 | 1 | 0 | 0 | 1 | 0 | 1 | 1 |
| 9 | 1 | 0 | 1 | 1 | 1 | 0 | 1 | 0 | 0 | 1 | 1 |
| 10 | 1 | 0 | 1 | 0 | 0 | 1 | 1 | 1 | 0 | 1 | 1 |
| 11 | 1 | 1 | 1 | 0 | 0 | 1 | 1 | 0 | 1 | 0 | 1 |
| 12 | 1 | 0 | 0 | 1 | 0 | 1 | 0 | 1 | 1 | 1 | 1 |
| 13 | 1 | 1 | 0 | 1 | 0 | 1 | 0 | 1 | 0 | 1 | 1 |
| 14 | 1 | 0 | 0 | 0 | 1 | 1 | 0 | 1 | 0 | 0 | 1 |
| 15 | 1 | 1 | 0 | 0 | 1 | 1 | 1 | 1 | 0 | 1 | 1 |
| 16 | 1 | 1 | 1 | 0 | 1 | 1 | 1 | 0 | 0 | 1 | 0 |
| 17 | 1 | 0 | 0 | 1 | 1 | 1 | 0 | 0 | 1 | 0 | 0 |
| 18 | 1 | 1 | 0 | 1 | 1 | 1 | 1 | 1 | 0 | 0 | 0 |
| 19 | 1 | 0 | 0 | 0 | 0 | 1 | 1 | 0 | 0 | 0 | 0 |
| 20 | 1 | 0 | 1 | 0 | 0 | 0 | 1 | 0 | 0 | 0 | 1 |
| 21 | 1 | 1 | 0 | 1 | 0 | 0 | 0 | 0 | 0 | 1 | 1 |
| 22 | 1 | 0 | 0 | 0 | 1 | 0 | 0 | 1 | 1 | 0 | 1 |
| 23 | 1 | 1 | 1 | 0 | 1 | 0 | 0 | 0 | 1 | 1 | 1 |
| 24 | 1 | 1 | 1 | 1 | 1 | 0 | 1 | 1 | 1 | 1 | 0 |
| 25 | 1 | 1 | 0 | 0 | 0 | 1 | 1 | 1 | 0 | 0 | 1 |
| 26 | 1 | 0 | 1 | 1 | 0 | 1 | 0 | 0 | 1 | 1 | 0 |
| 27 | 1 | 1 | 1 | 1 | 0 | 1 | 0 | 1 | 1 | 1 | 0 |
| 28 | 1 | 0 | 1 | 0 | 1 | 1 | 1 | 0 | 1 | 0 | 0 |
| 29 | 1 | 0 | 1 | 1 | 1 | 1 | 1 | 1 | 1 | 0 | 0 |
| 30 | 1 | 1 | 1 | 1 | 1 | 1 | 1 | 1 | 1 | 1 | 1 |
| 31 | 1 | 0 | 0 | 0 | 0 | 0 | 0 | 0 | 0 | 0 | 0 |

403. Perform Modulation.

A modulation scheme may be predefined, or the base station may notify the UE of the modulation scheme by using signaling. Table 1 in step 204 lists correspondence between a modulation and coding scheme index I_{MCS}, a modulation order Qₘ, and a transport block index I_{TBS} of a data channel. The UE may learn the modulation and coding scheme index I_{MCS} from downlink control information (Downlink Control Information, DCI) delivered by the base station, and may determine the modulation order Qₘ and the transport block index I_{TBS} by querying the table.

404. Perform Sending.

After grouping, the M groups of symbol streams need to be sent separately over M different time-frequency resources. A time-frequency resource includes a time resource (that is, M), where the M is at least greater than 1, may be equal to 1 to be compatible with the prior art (no grouping), or may be a multiple of 4 such as 4 ms or 8 ms, so as to reuse an HARQ process in a case of TTI bundling. For example, M=4, four transmission resources correspond to RB#4-5 of subframe #1, RB#2-3 of subframe #2, RB#15-16 of subframe #3, and RB#30-31 of subframe #4, respectively, where the time resources may be continuous or discontinuous. A size of a time resource may be notified by signaling or may be predefined; for example, a predefined size of a time domain is 16.

In a scheduling-based case, allocation of time-frequency resources may be determined by a base station and delivered to a UE by using signaling. Specifically, as an example, the base station may allocate all M groups of transmission resources by using DCI, where the DCI may include the number of RBs (PRB), a new MCS or an original MCS (or a new TBS), and value M or value N, and may further include a size of a time domain of a transmission resource.

In a contention-based case, the UE may first send a code, for example, an access code; this code may carry some information, for example, multiple time-frequency resources, for example, M, that the user needs to occupy; after successfully receiving the access code, the base station delivers acknowledgment information; and then the user continues to occupy a channel, until the transmission is completed. The occupied channel may be allocated by the base station, where information about the channel information is carried in the acknowledgment information; or may be a corresponding channel of the access code and/or a channel in which the access code is located. In a last transmission after the grouping, a feature may be added, for example, a spreading factor such as (1,−1) is used over a pilot, or a string of all-special symbols, such as <NULL> frequently used in LTE, is added after encoded data, to indicate to a receiver that the transmission is completed.

405. Feed Back Information.

Because the information stream in this embodiment is not added with check information, the grouped symbol streams may be independently demodulated and decoded at a receiving end, and the receiver may feed back an ACK/NACK to each of the received M groups of symbol streams; and certainly, an ACK/NACK may also be fed back after all M groups of symbol streams are received. If an NACK is fed back, over which time-frequency resource information is incorrect also needs to be fed back simultaneously. For example, a total of four groups of information are sent, and the first and the third are incorrect. In addition to feeding back an NACK, the receiver also feeds back a bitmap: 1010 to indicate which group is incorrect, for example, 0001 indicates that the first group is incorrect, and 0011 indicates that the third group is incorrect.

The following describes an example of step 401 to 405. It is assumed that the sender needs to send 20-byte information, that is, 20×8=160 bits, which are divided into 20 groups with 8 bits per group for transmission; and with RM(24,O), O=8, RM encoding is performed on each group of information streams.

In addition, if a manner of continuous sending without waiting for feedback is used, power consumption of the UE may be significantly saved. Further, no addition of check information is also a reduction of overhead.

Therefore, in a case of a low code rate, by grouping an information stream to be sent, transmission efficiency is ensured in this embodiment of the present invention. In addition, in a manner of RM encoding, overhead is saved, and encoding performance is improved.

In addition, as another embodiment, check information may be added in a high level to an information stream to be sent, so that the information stream is encoded and modulated without being added with CRC at the physical layer. The encoding includes Turbo code encoding, convolutional code encoding, or RM code encoding. A grouping process may be performed before encoding or after encoding (before modulation), or after modulation. For detailed steps, reference may be made to corresponding steps in FIG. 2 to FIG. 4, and therefore details are described herein again.

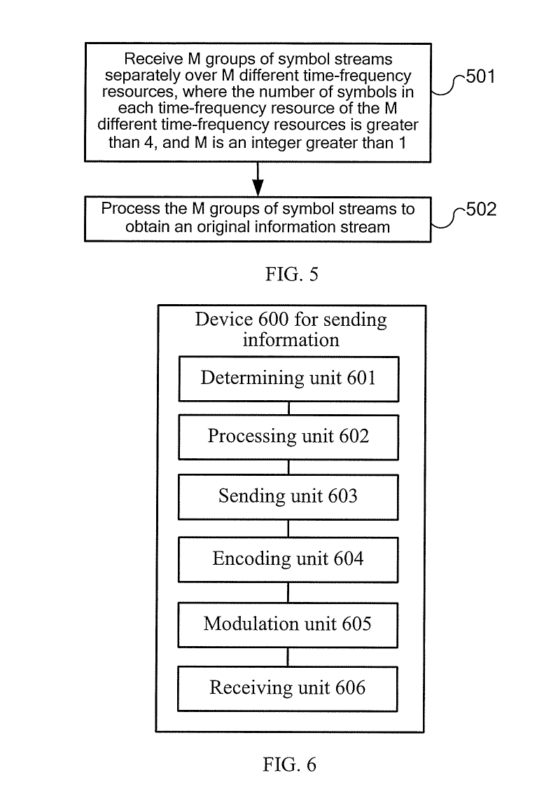

FIG. 5 is a flowchart of a method for receiving information according to an embodiment of the present invention.

501. Receive M groups of symbol streams separately over M different time-frequency resources, where the number of symbols in each time-frequency resource of the M different time-frequency resources is greater than 4, and M is an integer greater than 1.

502. Process the M groups of symbol streams to obtain an original information stream.

Based on the foregoing technical solutions, in a case of a low code rate, by grouping an information stream to be sent, transmission efficiency is ensured in this embodiment of the present invention.

Optionally, as an embodiment, in step 502, the processing the M groups of symbol streams to obtain an original information stream may include: separately demodulating the M groups of symbol streams to obtain M groups of bit streams, where a length of the bit streams is C, and a length of each group of bit streams is N; merging the M groups of bit streams to a bit stream to be decoded; decoding the bit stream to be decoded to obtain the original information stream, where the decoding includes Turbo code decoding or convolutional code decoding; and checking the original information stream.

Optionally, as an embodiment, in step 502, the processing the groups of symbol streams to obtain an original information stream may include: merging the M groups of symbol streams to a symbol stream to be demodulated, where a length of the symbol stream to be demodulated is C, and a length of each group of symbol streams is N; demodulating the symbol stream to be demodulated to obtain a bit stream to be decoded; decoding the bit stream to be decoded to obtain the original information stream, where the decoding includes Turbo code decoding or convolutional code decoding; and checking the original information stream.

Optionally, as an embodiment, in step 502, the processing the M groups of symbol streams to obtain an original information stream may include: separately demodulating the M groups of symbol streams to obtain M groups of bit streams to be decoded; separately performing linear block code decoding on the M groups of bit streams to be decoded to obtain M groups of bit streams; merging the M groups of bit streams into the original information stream, where a length of the original information stream is C, and a length of each group of bit streams is N; and checking the original information stream.

Optionally, as an embodiment, the checking the original information stream may include: cyclic redundancy check or high-level check information check; and the decoding may further include: linear block code decoding.

Optionally, as an embodiment, M may be determined according to N and C, or N may be determined according to M and C:

$$M = ⌈ \frac{C}{N} ⌉$$

$$or$$

$$N = ⌈ \frac{C}{M} ⌉$$

where the C and N are in units of bits, or the C and N are in units of symbols, N is an integer greater than or equal to 1, and ┌ ┐ is a round-up operation.

Optionally, as an embodiment, a receiving end may determine and send a resource allocation message, where the resource allocation message is used to configure a time-frequency resource occupied by each group of the M groups of symbol streams. The resource allocation message includes at least one of the following items: the number of groups M, a group size N, a time-domain size of the time-frequency resource occupied by each group, the number of resource blocks RBs and a modulation and coding scheme MCS, and the number of RBs and a transport block size TBS.

Optionally, as an embodiment, the receiving M groups of symbol streams separately over M different time-frequency resources includes: sending acknowledgment information to a user equipment after a first group of the M groups of symbol streams is successfully received, where the acknowledgment information is used to instruct that a current channel continues to be occupied in subsequent transmission.

Optionally, as an embodiment, after the receiving is complete, feedback for the M groups of symbol streams may be sent, or feedback for each group of symbol streams may be sent.

Therefore, in a case of a low code rate, by grouping an information stream to be sent, transmission efficiency is ensured in this embodiment of the present invention. In addition, overhead is saved in a manner of sharing a check code or using linear block code encoding.

FIG. 6 is a schematic block diagram of a device for sending information according to an embodiment of the present invention. As shown in FIG. 6, a device 600 for sending information includes a determining unit 601, a processing unit 602, and a sending unit 603, where:

the determining unit 601 determines the number of groups M and/or a group size N, where M is an integer greater than 1, and N is an integer greater than 1 or equal to 1; the processing unit 602 processes, according to M and/or N, an information stream to be grouped to obtain M groups of information streams to be sent; and the sending unit 603 sends, separately over M different time-frequency resources, the M groups of information streams to be sent, where the number of symbols in each time-frequency resource of the M different time-frequency resources is greater than 4.

In a case of a low code rate, by grouping an information stream to be sent, transmission efficiency is ensured in this embodiment of the present invention. In addition, in a manner of sharing a check code or using linear block coding, overhead is saved.

The device 600 for sending information may execute each step of the method embodiments shown in FIG. 1 to FIG. 4. For the purpose of avoiding repetition, details are not described herein again.

Optionally, as an embodiment, the device 600 for sending information may further include an encoding unit 604 and a modulation unit 605, and the processing unit 601 is specifically configured to: add a cyclic redundancy check code behind the information stream to be grouped; encode, by using the encoding unit 604, the information stream to be grouped to obtain a bit stream, where the information stream to be grouped is added with the cyclic redundancy check code, and the encoding includes Turbo code encoding or convolutional code encoding; divide the bit stream into M groups of bit streams to be modulated, where a length of the bit stream is C, and a length of each group of bit streams to be modulated is N; and separately modulate, by using the modulation unit 605, the M groups of bit streams to be modulated to obtain M groups of information streams to be sent. Similarly, the processing procedures in FIG. 3 and FIG. 4 may further be completed by the device 600 for sending information, and details are not described herein again.

Optionally, as an embodiment, the device 600 for sending information further includes a receiving unit 606, and the determining unit 601 is specifically configured to: locally acquire the preset number of the groups M and/or the group size N, or externally receive the number of the groups M and/or the group size N by using the receiving unit 606.

Optionally, the determining unit 601 is specifically configured to: determine M according to N and C, or determine N according to M and C:

$$M = ⌈ \frac{C}{N} ⌉$$

$$or$$

$$N = ⌈ \frac{C}{M} ⌉$$

where the C and N are in units of bits, or the C and N are in units of symbols, and ┌ ┐ is a round-up operation.

Optionally, as an embodiment, the receiving unit 606 is specifically configured to: externally receive a resource allocation message, where the resource allocation message is used to configure a time-frequency resource occupied by each group of the M groups of information streams to be sent. The resource allocation message includes at least one of the following items: the number of groups M, a group size N, a time-domain size of the time-frequency resource occupied by each group, the number of resource blocks RBs and a modulation and coding scheme MCS, and the number of RBs and a transport block size TBS.

Optionally, as an embodiment, the receiving unit 606 is specifically configured to: receive acknowledgment information sent by a base station after a first group of the M groups of information streams to be sent is successfully sent, where the acknowledgment information is used to instruct that a current channel continues to be occupied in subsequent transmission. The receiving unit 606 is further configured to: receive feedback for the M groups of information streams to be sent, or receive feedback for each group of information streams to be sent.

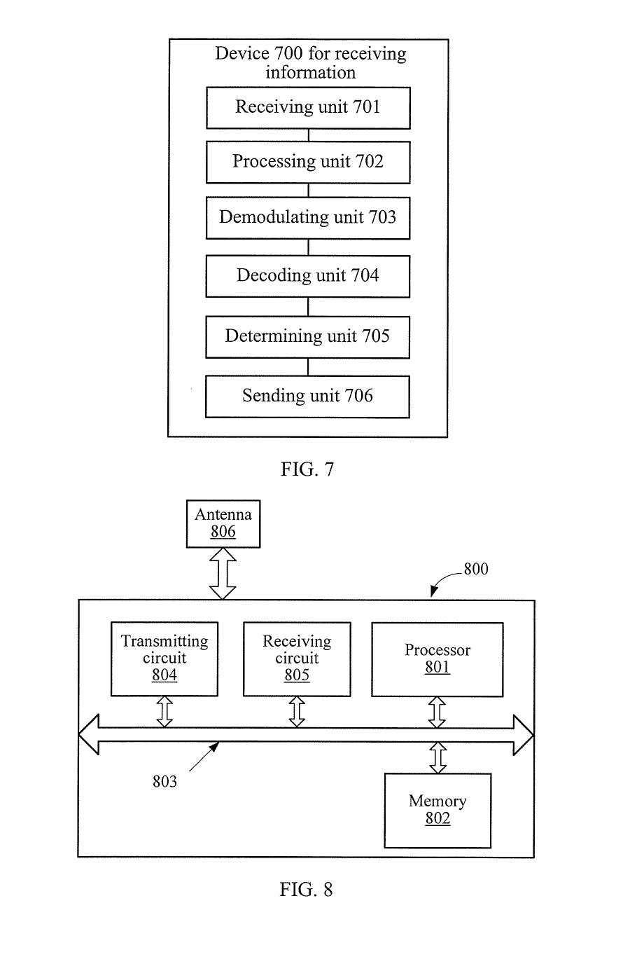

FIG. 7 is a schematic block diagram of a device for receiving information according to an embodiment of the present invention. As shown in FIG. 7, a device 700 for receiving information includes a receiving unit 701 and a processing unit 702.

The receiving unit 701 receives M groups of symbol streams separately over M different time-frequency resources, where the number of symbols in each time-frequency resource of the M different time-frequency resources is greater than 4, and M is an integer greater than 1. The processing unit 702 processes the M groups of symbol streams to obtain an original information stream.

In a case of a low code rate, by grouping an information stream to be sent, transmission efficiency is ensured in this embodiment of the present invention. In addition, in a manner of sharing a check code or using linear block coding, overhead is saved.

The device 700 for receiving information may execute each step of the method embodiment shown in FIG. 5. For the purpose of avoiding repetition, details are not described herein again.

Optionally, as an embodiment, the device 700 for receiving information further includes a demodulation unit 703 and a decoding unit 704, and the processing unit 702 is specifically configured to: separately demodulate the M groups of symbol streams by using the demodulation unit 704 to obtain M groups of bit streams, where a length of the bit streams is C, and a length of each group of bit streams is N; merge the M groups of bit streams to a bit stream to be decoded; decode, by using the decoding unit 703, the bit stream to be decoded to obtain the original information stream, where the decoding includes Turbo code decoding or convolutional code decoding; and check the original information stream.

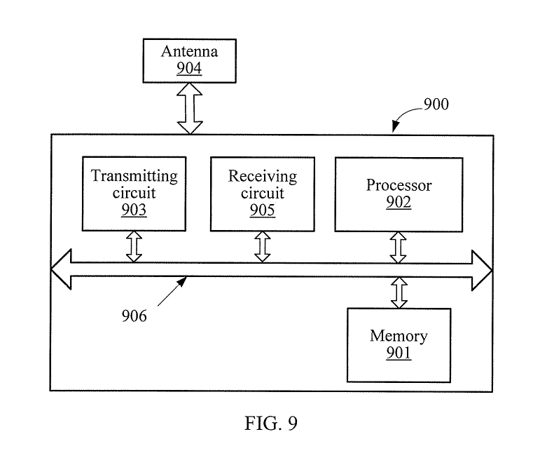

FIG. 8 is a schematic block diagram of a device for sending information according to another embodiment of the present invention. In FIG. 8, a device 800 for sending information includes a processor 801 and a memory 802. The processor 801 and the memory 802 are connected by a bus system 803.

The memory 802 is configured to store an instruction for the processor 801 to execute the following operations: determine the number of groups M and/or a group size N, where M is an integer greater than 1, and N is an integer greater than 1 or equal to 1; process, according to M and/or N, an information stream to be grouped to obtain M groups of information streams to be sent; and send, separately over M different time-frequency resources, the M groups of information streams to be sent, where the number of symbols in each time-frequency resource of the M different time-frequency resources is greater than 4.

In a case of a low code rate, by grouping an information stream to be sent, transmission efficiency is ensured in this embodiment of the present invention. In addition, by sharing a check code or using linear block coding, overhead is saved.

In addition, the device 800 for sending information may further include a transmitting circuit 804, a receiving circuit 805, and an antenna 806. The processor 801 controls an operation of the device 800 for sending information, and the processor 801 may also be called a CPU (Central Processing Unit, central processing unit). The memory 802 may include a read-only memory and a random access memory, and provide an instruction and data for the processor 801. Part of the memory 802 may further include a nonvolatile random access memory (NVRAM). In a specific application, the transmitting circuit 804 and the receiving circuit 805 may be coupled to the antenna 806. Components of the device 800 for sending information are coupled by using the bus system 803, where in addition to including a data bus, the bus system 803 may further include a power bus, a control bus, and a status signal bus. However, for clarity of description, each bus in the figure is labeled as the bus system 803.

The methods disclosed in the foregoing embodiments of the present invention may be applied in the processor 801, or implemented by the processor 801. The processor 801 may be an integrated circuit chip having a capability of signal processing. In an implementation process, each step of the foregoing method may be completed by an integrated logic circuit in hardware of the processor 801, or by an instruction in a form of software. The processor 801 may be a general processor, a digital signal processor (DSP), an application-specific integrated circuit (ASIC), a field programmable gate array (FPGA), or another programmable logic device, an independent gate or a transistor logic device, or an independent hardware component, and may implement or execute various methods, steps, or logic block diagrams disclosed in the embodiments of the present invention. The general processor may be a microprocessor; or the processor may also be any conventional processor or the like. Steps with reference to the methods disclosed in the embodiments of the present invention may be directly executed and completed by hardware of a decoding processor, or executed and completed by a combination of the hardware and a software module of the decoding processor. The software module may be placed in a storage medium that is mature in the art, such as a random access memory, a flash memory, a read-only memory, a programmable read-only memory, an electrically erasable programmable memory, or a register. The storage medium is located in the memory 802; and the processor 801 reads information from the memory 802 and completes steps of the foregoing methods in combination with its hardware.

Optionally, as an embodiment, the processor 801 may add a cyclic redundancy check code behind the information stream to be grouped; encode the information stream to be grouped to obtain a bit stream, where the information stream to be grouped is added with the cyclic redundancy check code, and the encoding includes Turbo code encoding or convolutional code encoding; divide the bit stream into M groups of bit streams to be modulated, where a length of the bit stream is C, and a length of each group of bit streams to be modulated is N; and separately modulate the M groups of bit streams to obtain M groups of information streams to be sent.

Optionally, as another embodiment, the processor 801 may add a cyclic redundancy check code behind the information stream to be grouped; encode the information stream to be grouped to obtain a bit stream, where the information stream to be grouped is added with the cyclic redundancy check code, and the encoding includes Turbo code encoding or convolutional code encoding; modulate the bit stream to obtain a symbol stream; and divide the symbol stream into M groups of information streams to be sent, where a length of the symbol stream is C, and a length of each group of information streams to be sent is N.

Optionally, as another embodiment, the processor 801 may divide the information stream to be grouped into M groups of information streams to be encoded, where a length of the information stream to be grouped is C, and a length of each group of information streams to be encoded is N; perform linear block code encoding on the M groups of information streams to be encoded to obtain M groups of bit streams; and separately modulate the M groups of bit streams to obtain M groups of information streams to be sent.

Optionally, as another embodiment, the processor 801 may divide the information stream to be grouped into M groups of information streams to be encoded, where a length of the information stream to be grouped is C, a length of each group of information streams to be encoded is N, and the information stream to be grouped includes high-level check information; encode the M groups of information streams to be encoded to obtain M groups of bit streams, where the encoding includes Turbo code encoding, convolutional code encoding, or linear block code encoding; and modulate the M groups of bit streams to obtain M groups of information streams to be sent.

Optionally, as another embodiment, the processor 801 may encode the information stream to be grouped to obtain a bit stream, where the encoding includes Turbo code encoding, convolutional code encoding, or linear block code encoding, and the information stream to be grouped includes high-level check information; divide the bit stream into M groups of bit streams to be modulated, where a length of the bit stream is C, and a length of each group of bit streams to be modulated is N; and modulate the M groups of bit streams to be modulated to obtain M groups of information streams to be sent.

Optionally, as another embodiment, the processor 801 may encode the information stream to be grouped to obtain a bit stream, where the encoding includes Turbo code encoding, convolutional code encoding, or linear block code encoding, and the information stream to be grouped includes high-level check information; modulate the bit stream to obtain a symbol stream; and divide the symbol stream into M groups of information streams to be sent, where a length of the symbol stream is C, and a length of each group of information streams to be sent is N.

Optionally, as another embodiment, in a scheduling-based case, the receiving circuit 805 may externally receive a resource allocation message by using the antenna 806, where the resource allocation message is used to configure a time-frequency resource occupied by each group of M groups of information streams to be sent. The resource allocation message includes at least one of the following items: the number of groups M, a group size N, a time-domain size of the time-frequency resource occupied by each group, the number of resource blocks RBs and a modulation and coding scheme MCS, and the number of RBs and a transport block size TBS.

Optionally, as another embodiment, in a contention-based case, after a first group of M groups of information streams to be sent is successfully sent, the receiving unit 805 may receive, by using the antenna 806, acknowledgment information sent by a base station, where the acknowledgment information is used to instruct that a current channel continues to be occupied in subsequent transmission.

Optionally, as another embodiment, the receiving circuit 805 may receive, by using the antenna 806, feedback for M groups of information streams to be sent, or feedback for each group of information streams to be sent.

FIG. 9 is a schematic block diagram of a device for receiving information according to another embodiment of the present invention. In FIG. 9, a device 900 for receiving information includes a memory 901, a processor 902, a transmitting circuit 903, and an antenna 904.

The memory 901 is configured to store an instruction for the processor 902 to execute the following operations: receive M groups of symbol streams separately over M different time-frequency resources, where the number of symbols in each time-frequency resource of the M different time-frequency resources is greater than 4, and M is an integer greater than 1; and process the M groups of symbol streams to obtain the original information stream.

In a case of a low code rate, by grouping an information stream to be sent, transmission efficiency is ensured in this embodiment of the present invention. In addition, by sharing a check code or using linear block coding, overhead is saved.

In addition, the device 900 for receiving information may further include a receiving circuit 905 and the like. The processor 902 controls an operation of a base station 900; and the processor 902 may also be called a CPU (Central Processing Unit, central processing unit). The memory 901 may include a read-only memory and a random access memory, and provides an instruction and data for the processor 902. Part of the memory 901 may further include a nonvolatile random access memory (NVRAM). In a specific application, the transmitting circuit 903 and the receiving circuit 905 may be coupled to the antenna 904. Components of the device 900 for receiving information are coupled by using a bus system 906, where in addition to including a data bus, the bus system 906 may also include a power bus, a control bus, and a status signal bus. However, for clarity of description, each bus in the figure is labeled as the bus system 906.

The methods disclosed in the embodiments of the present invention may be applied in the processor 902, or implemented by the processor 902. The processor 902 may be an integrated circuit chip having a capability of signal processing. In an implementation process, each step of the foregoing methods may be completed by an integrated logic circuit in hardware of the processor 902, or by an instruction in a form of software. The processor 902 may be a general processor, a digital signal processor (DSP), an application-specific integrated circuit (ASIC), a field programmable gate array (FPGA), or another programmable logic device, an independent gate or a transistor logic device, or an independent hardware component, and may implement or execute various methods, steps, or logic block diagrams disclosed in the embodiments of the present invention. The general processor may be a microprocessor; or the processor may also be any conventional processor or the like. Steps in combination with the methods disclosed in the embodiments of the present invention may be executed and completed by hardware of a decoding processor, or executed and completed by a combination of the hardware and a software module of the decoding processor. The software module may be placed in a storage medium that is mature in the art, such as a random access memory, a flash memory, a read-only memory, a programmable read-only memory, an electrically erasable programmable memory, or a register. The storage medium is located in the memory 901; and the processor 902 reads information from the memory 901 and completes steps of the foregoing methods in combination with its hardware.

Optionally, as an embodiment, the processor 902 separately demodulates M groups of symbol streams to obtain M groups of bit streams, where a length of the bit stream is C, and a length of each group of bit streams is N; merges the M groups of bit streams to a bit stream to be decoded; decodes the bit stream to be decoded to obtain the original information stream, where the decoding includes Turbo code decoding or convolutional code decoding; and checks the original information stream

Optionally, as an embodiment, the processor 902 merges M groups of symbol streams to a symbol stream to be demodulated, where a length of the symbol stream to be demodulated is C, and a length of each group of symbol streams is N; demodulates the symbol stream to be demodulated to obtain a bit stream to be decoded; decodes the bit stream to be decoded to obtain the original information stream, where the decoding includes Turbo code decoding or convolutional code decoding; and checks the original information stream.

Optionally, as an embodiment, the processor 902 separately demodulates M groups of symbol streams to obtain M groups of bit streams to be decoded; separately performs linear block code decoding on the M groups of bit streams to be decoded to obtain M groups of bit streams; merges the M groups of bit streams to the original information stream, where a length of the original information stream is C, and a length of each group of bit streams is N; and checks the original information stream.

A person of ordinary skill in the art may be aware that, in combination with the examples described in the embodiments disclosed in this specification, method steps and units may be implemented by electronic hardware, computer software, or a combination of thereof. To clearly describe the interchangeability between the hardware and the software, the foregoing has generally described compositions and steps of each example according to functions. Whether the functions are performed by hardware or software depends on particular applications and design constraint conditions of the technical solution. A person of ordinary skill in the art may use different methods to implement the described functions for each particular application, but it should not be considered that the implementation goes beyond the scope of the present invention.

The methods or steps described in combination with the embodiments disclosed herein may be implemented using hardware, a software program executed by a processor, or the combination thereof. The software program may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form well-known in the technical field.

The present invention is described in detail with reference to the accompanying drawings in combination with the exemplary embodiments, but it is not limited to the foregoing. Various equivalent modifications or replacements made by a person skilled in the art without departing from the spirit and essence of the present invention shall fall within the scope of the present invention.

What is claimed is:

1. A method for sending information, the method comprising:
obtaining at least one of the number of groups M and a group size N, wherein the M is an integer greater than 1, and the N is an integer greater than 1 or equal to 1;
obtaining M groups of information streams by processing, according to the obtained M and/or N, a first information stream; and
sending, separately over M different time-frequency resources, the M groups of information streams, wherein the number of symbols in each time-frequency resource of the M different time-frequency resources is greater than 4.

2. The method according to claim 1, wherein obtaining M groups of information streams comprises:
obtaining a second information stream by adding a cyclic redundancy check code behind the first information stream;
obtaining a bit stream by encoding the second information stream, wherein the encoding comprises Turbo code encoding or convolutional code encoding, and a length of the bit stream is C;
dividing the bit stream into M groups of bit streams, wherein a length of each group of bit streams is N; and
obtaining the M groups of information streams by separately modulating the M groups of bit streams.

3. The method according to claim 1, wherein obtaining M groups of information streams comprises:
obtaining a second information stream by adding a cyclic redundancy check code behind the first information stream;
obtaining a bit stream by encoding the second information stream, wherein the encoding comprises Turbo code encoding or convolutional code encoding;
modulating the bit stream to obtain a symbol stream, wherein a length of the symbol stream is C; and
dividing the symbol stream into M groups of information streams, wherein a length of each group of information streams is N.

4. The method according to claim 1, wherein obtaining the number of groups M and/or a group size N comprises:
receiving the number of the groups M and/or the group size N from a device.

5. The method according to claim 1, wherein obtaining the number of groups M and/or a group size N comprises:
obtaining the M according to the N and the C:
$$M = ⌈ \frac{C}{N} ⌉$$
or obtaining the N according to the M and the C:
$$N = ⌈ \frac{C}{M} ⌉$$
wherein the C and N are in units of bits, or the C and N are in units of symbols, and ┌ ┐ is a round-up operation.

6. The method according to claim 4, wherein receiving the number of the groups M and/or the group size N comprises:
receiving a resource allocation message, wherein the resource allocation message is used to configure a time-frequency resource occupied by each group of the M groups of information streams.

7. The method according to claim 6, wherein the resource allocation message comprises at least one of the following items:
the number of the groups M;
the group size N;
a length of a time domain of the time-frequency resource occupied by each group;
the number of resource blocks (RBs) and a modulation and coding scheme (MCS); and
the number of RBs and a transport block size (TBS).

8. The method according to claim 1, further comprising:
receiving feedback for the M groups of information streams; or
receiving feedback for each group of information streams.

9. A device for sending information, the device comprising:
a processor;
a transmitter coupled with the processor;
a receiver coupled with the processor;
wherein the processor is configured to:
obtain at least one of the number of groups M and a group size N, wherein the M is an integer greater than 1, and the N is an integer greater than 1 or equal to 1, and
obtain M groups of information streams by processing, according to the obtained M and/or N, a first information stream; and
wherein the transmitter is configured to send, separately over M different time-frequency resources, the M groups of information streams, wherein the number of symbols in each time-frequency resource of the M different time-frequency resources is greater than 4.

10. The device according to claim 9, wherein the processor is further configured to:
obtain a second information stream by adding a cyclic redundancy check code behind the first information stream;
obtain a bit stream by encoding the second information stream, wherein the encoding comprises Turbo code encoding or convolutional code encoding, and a length of the bit stream is C;
divide the bit stream into PI groups of bit streams, wherein a length of each group of bit streams is N; and
obtain the M groups of information streams by separately modulating the M groups of bit streams.

11. The device according to claim 9, wherein the processor is further configured to:
obtain a second information stream by adding a cyclic redundancy check code behind the first information stream;
obtain a bit stream by encoding the second information stream, wherein the encoding comprises Turbo code encoding or convolutional code encoding;
obtain a symbol stream by modulating the bit stream, wherein a length of the symbol stream is C; and
divide the symbol stream into M groups of information streams, wherein a length of each group of information streams is N.

12. The device according to claim 9, wherein the processor is further configured to:
obtain the number of the groups M and/or the group size N in accordance with information in a message that is received from another device.

13. The device according to claim 9, wherein the processor is further configured to:
obtain the M according to the N and the C:
$$M = ⌈ \frac{C}{N} ⌉ ,$$
or obtain the N according to the M and the C:
$$N = ⌈ \frac{C}{M} ⌉ ,$$
wherein the C and N are in units of bits, or the C and N are in units of symbols, and ┌ ┐ is a round-up operation.

14. The device according to claim 12, wherein the message is a resource allocation message is used to configure a time-frequency resource occupied by each group of the M groups of information streams.

15. The device according to claim 14, wherein the resource allocation message comprises at least one of the following items:
the number of the groups M;
the group size N;
a length of a time domain of the time-frequency resource occupied by each group;
the number of resource blocks (RBs) and a modulation and coding scheme (MCS); and
the number of RBs and a transport block size (TBS).

16. The device according to claim 9, wherein the receiver is configured to:
receive feedback for the M groups of information streams; or
receive feedback for each group of information streams.

17. A chip, comprising:
a first unit, configured to obtain the number of groups M and/or a group size N, wherein the M is an integer greater than 1, and the N is an integer greater than 1 or equal to 1;
a second unit, configured to obtain M groups of information streams by processing, according to the obtained M and/or the N, a first information stream; and
a third unit, configured to cause a transmitter to send, separately over M different time-frequency resources, the M groups of information streams, wherein the number of symbols in each time-frequency resource of the M different time-frequency resources is greater than 4.

18. The chip according to claim 17, wherein the second unit is further configured to:
obtain a second information stream by adding a cyclic redundancy check code behind the first information stream;
obtain a bit stream by encoding the second information stream, wherein the encoding comprises Turbo code encoding or convolutional code encoding, and a length of the bit stream is C;
divide the bit stream into M groups of bit streams, wherein a length of each group of bit streams is N; and
obtain the M groups of information streams by separately modulating the M groups of bit streams.

19. The chip according to claim 17, wherein the second unit is further configured to:
obtain a second information stream by adding a cyclic redundancy check code behind the first information stream;
obtain a bit stream by encoding the second information stream, wherein the encoding comprises Turbo code encoding or convolutional code encoding;
obtain a symbol stream by modulating the bit stream, wherein a length of the symbol stream is C; and
divide the symbol stream into M groups of information streams, wherein a length of each group of information streams is N.

20. The chip according to claim 17, wherein the first unit is configured to:
obtain the number of the groups M and/or the group size N from a message received from another device.

21. The chip according to claim 20, wherein the message is a resource allocation message from the other device and is used to configure a time-frequency resource occupied by each group of the M groups of information streams.

22. The chip according to claim 21, wherein the resource allocation message comprises at least one of the following items:
the number of the groups M;
the group size N;
a length of a time domain of the time-frequency resource occupied by each group;
the number of resource blocks (RBs) and a modulation and coding scheme (MCS); and
the number of RBs and a transport block size (TBS).
